(19) United States
(12) Patent Application Publication
(10) Pub. No.: US 2006/0002488 A1
(43) Pub. Date: Jan. 5, 2006

(54) Communication device capable of performing broadband radio communication

(76) Inventor: Yutaka Asanuma, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/170,315

(22) Filed: Jun. 30, 2005

(30) Foreign Application Priority Data
Jun. 30, 2004 (JP) 2004-194571

(51) Int. Cl. H04L 27/02

(52) U.S. Cl. 375/268

(57) ABSTRACT

A communication device includes a communication unit capable of performing radio communications in a broad band including a first band whose frequency is relatively higher and a second band whose frequency is relatively lower. The communication device further includes, for example, a determination unit which determines whether or not a channel in the first band is usable, and a control unit which preferentially assigns data to be transmitted or received to the channel in the first band when the channel in the first band is usable.

### CROSS-REFERENCE TO RELATED APPLICATIONS

This application is based upon and claims the benefit of priority from prior Japanese Patent Application No. 2004-194571, filed Jun. 30, 2004, the entire contents of which are incorporated herein by reference.

### BACKGROUND OF THE INVENTION

1. Field of the Invention

The present invention relates to a communication device capable of performing broadband radio communications.

2. Description of the Related Art

In recent years, a system using a very broad frequency range, such as an ultra wideband communication system that is under deliberation in the IEEE 802.15 committee, has been proposed.

For example, McLaughlin, ParthusCeva, Welborn, XSI & Kohno, and CRL-UWB Consortium, “Merger#2 Proposal DS-CDMA,” doc.: IEEE 802.15-03/334r5, Nov. 10, 2003, slides 7, 8, 9 and 34 describes that a band in use is made up of a low-band channel and a high-band channel. The data transmission rate corresponding to the low-band channel ranges from 29 Mbps to 450 Mbps, while the data transmission rate corresponding to the high-band channel ranges from 29 Mbps to 900 Mbps. The bandwidth of the high band is about twice as large as that of the low band. These channels can be used in the following three ways: only the low-band channel, only the high-band channel, and both the low-band and high-band channels (multi-band channel). The above document also describes selecting a channel according to the data transmission rate and selecting a channel when a plurality of Piconets coexist with each other.

Anuj Batra et al. and Texas Instruments et al., “Multi-Band OFDM Physical Layer Proposal for IEEE 802.15 Task Group 3a,” doc.: IEEE 802.15-03/268r2, Nov. 10, 2003, pp. 35-36 describes dividing a band in use into thirteen bands and subjecting the bands to frequency hopping to transmit data through one channel. There are two systems: one is that three bands correspond to one channel, and the other is that seven bands correspond to one channel. The merits and demerits of the two systems vary with the number of Piconets that operate at the same time. In other words, a channel can be selected in accordance with the number of Piconets that operate at the same time.

In broadband radio communications such as ultra wideband communications, however, the propagation loss greatly varies from channel to channel. While the propagation loss is high in a channel in the high-frequency band, it is low in a channel in the low-frequency band. Therefore, no broadband radio communications can be carried out satisfactorily unless data is assigned to each channel with efficiency.

Unless data is assigned to each channel after due consideration of the status of use of a channel in each band, the characteristic of data to be transmitted, or the surroundings of a communication device, communications are difficult to perform more efficiently.

Under the circumstances, it is desired to propose a technique of improving in communications efficiency in broadband radio communications.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of a communication device common to first to fifth embodiments of the present invention;

FIG. 2 is a schematic diagram of the arrangement of channels of a radio communication system that is applied to the communication device shown in FIG. 1;

FIG. 3 is a graph showing a relationship between the band frequency and the propagation loss (in both transmission and reception) in the radio communication system that is applied to the communication device shown in FIG. 1;

FIGS. 4A and 4B are illustrations of a method of controlling communications according to the first embodiment of the present invention;

FIG. 5 is a flowchart illustrating a procedure of controlling communications according to the first embodiment of the present invention;

FIG. 6 is an illustration of a first method of controlling communications according to the second embodiment of the present invention;

FIG. 7 is a flowchart illustrating a procedure of the first method of controlling communications according to the second embodiment of the present invention;

FIG. 8 is an illustration of a second method of controlling communications according to the second embodiment of the present invention;

FIG. 9 is a flowchart illustrating a procedure of the second method of controlling communications according to the second embodiment of the present invention;

FIG. 10 is an illustration of a third method of controlling communications according to the second embodiment of the present invention;

FIG. 11 is a flowchart illustrating a procedure of the third method of controlling communications according to the second embodiment of the present invention;

FIG. 12 is an illustration of a method of controlling communications according to the third embodiment of the present invention;

FIG. 13 is a flowchart illustrating a procedure of controlling communications according to the third embodiment of the present invention;

FIG. 14 is an illustration of a method of controlling communications according to the fourth embodiment of the present invention;

FIG. 15 is a flowchart illustrating a procedure of controlling communications according to the fourth embodiment of the present invention;

FIG. 16 is an illustration of a method of controlling communications according to a fifth embodiment of the present invention; and

FIG. 17 is a flowchart illustrating a procedure of controlling communications according to the fifth embodiment of the present invention.

### DETAILED DESCRIPTION OF THE INVENTION

Embodiments of the present invention will be described below with reference to the drawings.

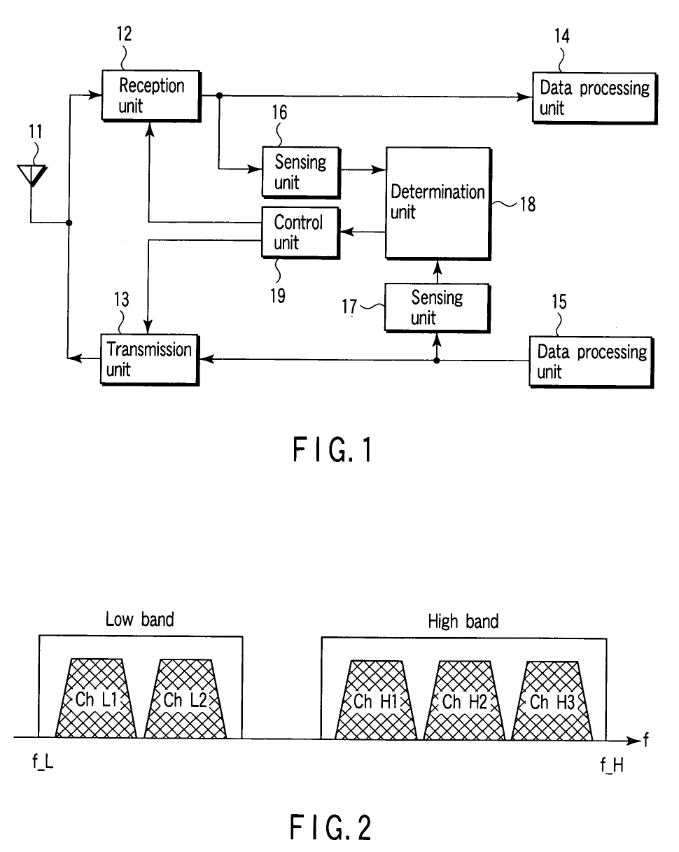

FIG. 1 is a block diagram showing a configuration of a communication device common to the first to fifth embodiments of the present invention.

The communication device has a function of performing radio communications in a wide band including a first band whose frequency is relatively higher and a second band whose frequency is relatively lower. The device can be applied to a combination of the 2.4G and 5G bands on the IEEE 802.11 standard as well as ultra wideband communications under deliberation in the IEEE 802.15 committee. Referring to FIG. 1, the communication device includes an antenna 11, a reception unit 12, a transmission unit 13, a reception data processing unit 14, a transmission data processing unit 15, a reception data sensing unit 16, a transmission data sensing unit 17, a determination unit 18 and a control unit 19.

The antenna 11 transmits/receives information to/from an antenna of another communication device by radio waves. The antenna 11 may include a plurality of antenna units (different antenna patterns). For example, it may include a first antenna unit the degree of directivity of which is relatively lower and a second antenna unit the degree of directivity of which is relatively higher.

The reception unit 12 receives data from the antenna 11 and supplies it to the data processing unit 14 under the control of the control unit 19. The transmission unit 13 receives data from the data processing unit 15 and supplies it to the antenna 11 under the control of the control unit 19 such that it can be transmitted to another communication device.

The data processing unit 14 subjects a necessary process to the data supplied from the reception unit 12 and then outputs it to one or more AV devices. The data processing unit 15 subjects a necessary process to the data sent from the AV devices and then supplies it to the transmission unit 13.

The reception data sensing unit 16 can sense various information items (transmission rate or speed of data, transmission quality required by a communication device on the other party, status of each channel, interference level of a Piconet, field intensity, distance of communications, etc.) about data output from the reception unit 12. It sends out a sensing result to the determination unit 18.

The transmission data sensing unit 17 can sense various information items (transmission rate of data, transmission quality required by an AV device, etc.) about data sent from the data processing unit 15. It sends out a sensing result to the determination unit 18.

The determination unit 18 performs various determinations (whether or not each channel is usable, about a relationship in transmission rate between transmission data and between reception data, about a relationship in communications distance between communication devices on the other party, about a relationship in degree of directivity between antennas) based on the sensing results of the sensing units 16 and 17. The determination unit 18 can be configured to store determination results in a given storage region and read them out when the need arises.

The control unit 19 controls data that is received by the reception unit 12 and transmitted from the transmission unit 13 (assigns data to a channel) based on the determination results of the unit 18.

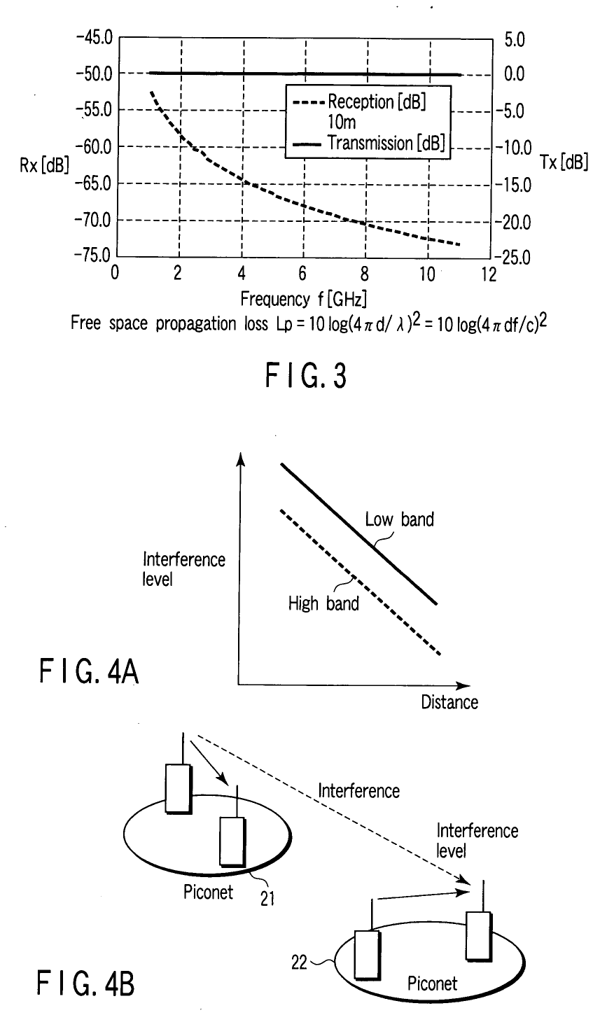

FIG. 2 is a schematic diagram of the arrangement of channels of a radio communication system that is applied to the communication device shown in FIG. 1. FIG. 3 is a graph showing a relationship between the band frequency and the propagation loss (in both transmission and reception) in the radio communication system. The free space propagation loss is calculated by the following equation:
Lp=10log(4πd/λ)²=10log(4πdf/c)²
where d is propagation distance, λ is wavelength, f is frequency and c is speed of light.

In the radio communication system, a usable band is divided into a first band whose frequency is relatively higher (referred to as a high band hereinafter) and a second band whose frequency is relatively lower (referred to as a low band hereinafter) as shown in FIG. 2. The low band includes a plurality of channels Ch_L1 and Ch_L2 and the high band includes a plurality of channels Ch_H1, Ch_H2 and Ch_H3.

Assume here that the minimum value and the maximum value of the frequency of a band usable in the radio communication system are f_L and f_H, respectively. As is apparent from FIG. 3, when the value of f_H/f_L exceeds the square root “2,” the propagation loss at the maximum value f_H is 3 dB larger than that at the minimum value f_L. The wider a difference in frequency (a difference in wavelength), the wider a difference in propagation loss. In order to prevent the difference from becoming wide, a prior art antenna, a prior art radio signal processing circuit and the like need to be modified extensively. Such a problem can be resolved by the following first to fifth embodiments of the present invention.

### First Embodiment

FIGS. 4A and 4B are illustrations of a method of controlling communications according to the first embodiment of the present invention.

FIG. 4A illustrates a difference in interference level between a low band and a high band. FIG. 4B illustrates an interference occurring in communications between two Piconets.

Assume that a first Piconet 21 interferes with a second Piconet 22 as shown in FIG. 4B. The propagation loss varies from the low band to the high band to be used for data transmission and so does the interference level as shown in FIG. 4A. In other words, the interference level becomes lower when the high band is used than when the low band is used. In the first embodiment, a high-band channel is preferentially selected to transmit or receive data. If any high-band channel cannot be selected because all the high-band channels are in use or the like, a low-band channel is selected thereby to prevent the communication device which belongs to Piconet 22 from being subjected to a great interference.

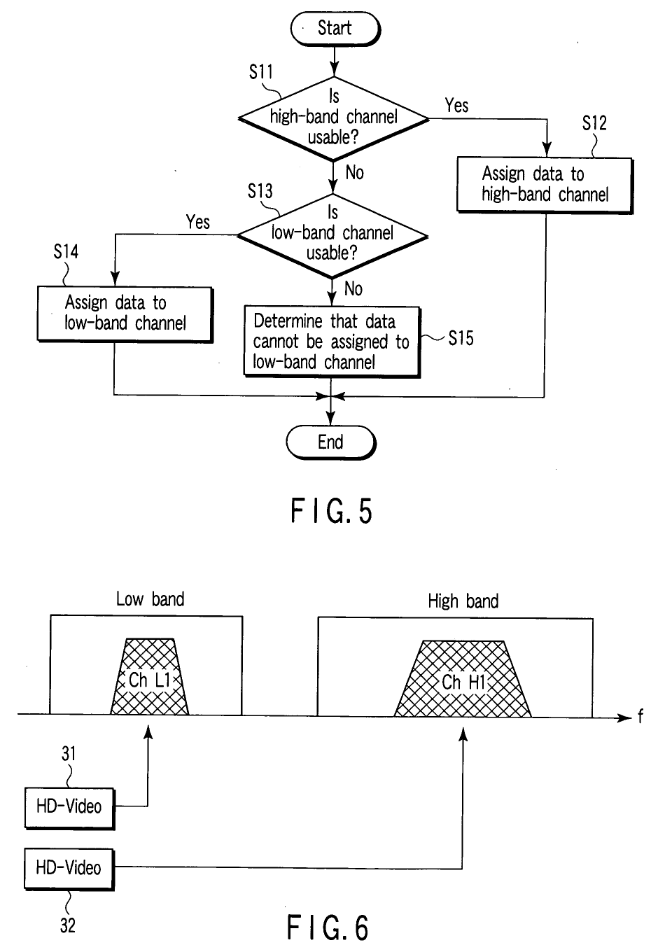

A procedure of controlling communications according to the first embodiment will be described with reference to FIG. 5.

Assume here that data is sent from an AV device to the transmission unit 13 through the data processing unit 15 and then transmitted therefrom through the antenna 11 in the communication device shown in FIG. 1. In this case, the determination unit 18 and control unit 19 perform the following processes.

The determination unit 18 determines whether or not a channel in the high band is usable (step S11). If it is usable (YES in step S11), the control unit 19 assigns data to be transmitted to this channel preferentially (step S12). When a channel in the high band is not usable (No in step S11), the determination unit 18 determines whether or not a channel in the low band is usable (step S13). If it is usable (YES in step S13), the control unit 19 assigns data to be transmitted to this channel (step S14). If the channel in the low band is not usable (No in step S13), the determination unit 18 determines that the data cannot be assigned to the low-band channel and stops performing an assigning process or stands by until the data can be assigned (step S15).

Specifically, the determination unit 18 determines that a channel is not usable, for example:
1) when the channel is explicitly shown as one in use;
2) when the interference level of a Piconet exceeds a predetermined value;
3) when the signal-to-noise (S/N) ratio falls below a predetermined value.

Combination of at least two of 1) to 3) may be adopted.

According to the first embodiment, since a channel in a high band with a large propagation loss is preferentially selected, the interference given from one Piconet to another Piconet can be reduced, and vice versa.

### Second Embodiment

The second embodiment of the present invention will be described with reference to FIGS. 6 to 11.

In the second embodiment, communications are so controlled that a data transmission rate per unit band is lower in the case where a high-band channel is used, than the case where a low-band channel is used. When power per unit band is fixed, power to be transmitted per information using a high-band channel is larger than using a low-band channel. It is thus possible to reduce a tendency that a propagation loss is higher when a high-band channel is used. When data items of the same transmission rate or the same required quality are transmitted through both the high and low-band channels, almost the same transfer distance and transmission characteristics as those in the low band can be obtained even in the high band. When data items whose transfer rates are different between the high and low bands are transmitted, if the data item whose transmission rate is lower is transmitted through a high-band channel, almost the same transfer distance and transmission characteristics can be obtained in both the high and low bands. Data items can thus be assigned to their respective channels with efficiency.

The following are specific three methods of controlling communications according to the second embodiment.

FIG. 6 is an illustration of the first method of controlling communications.

Assume here that a first high-definition video data (HD-Video) item 31 (for one channel) and a second high-definition video data (HD-Video) item 32 (for one channel) whose transmission rates are substantially the same are transmitted through a low-band channel Ch_L1 and a high-band channel Ch_H1, respectively, as shown in FIG. 6. The bandwidth of the high-band channel is greater than that of the low-band channel. Using the high-band channel rather than the low-band channel, a data transmission rate per unit band width becomes low and almost the same transfer distance and transmission characteristics can be obtained in both high and low bands.

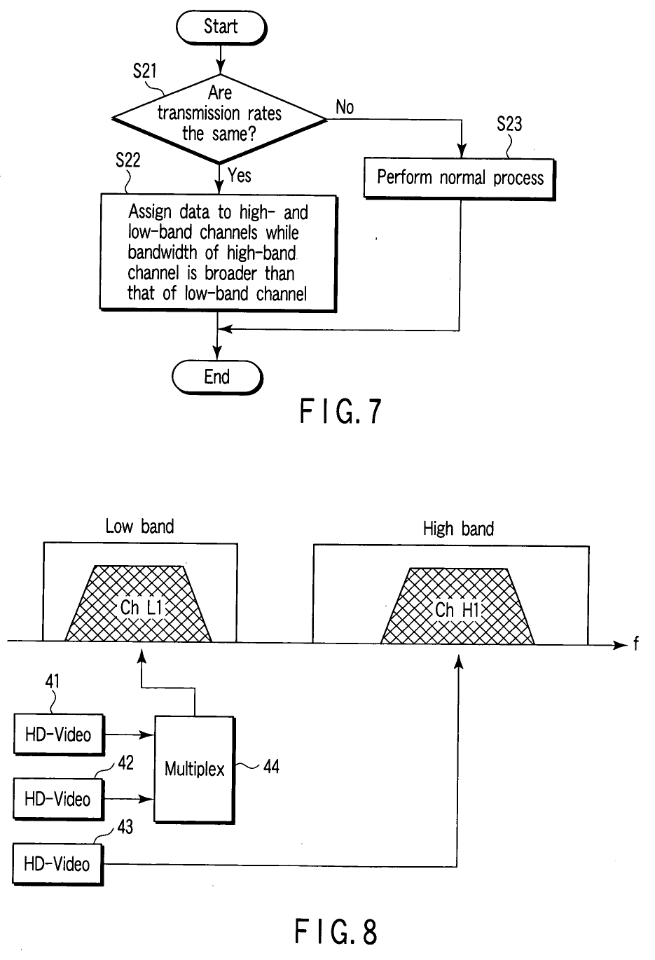

A procedure of the first method of controlling communications will be described with reference to FIG. 7.

Assume in the communication device shown in FIG. 1 that the data items 31 and 32 are supplied from an AV device to a transmission unit 13 through a data processing unit 15 and then transmitted via an antenna 11. A determination unit 18 and a control unit 19 perform the following processes.

The determination unit 18 determines whether or not the transmission rates of the data items 31 and 32 are the same (step S21). If they are the same (Yes in step S21), the control unit 19 assigns the data item 31 to a high-band channel and assigns the data item 32 to a low-band channel while the bandwidth of the high-band channel is broader than that of the low-band channel (step S22). If the transmission rates are different (No in step S21), the control unit 19 does not perform the process of step S22 (step S23).

FIG. 8 is an illustration of the second method of controlling communications according to the second embodiment.

Assume here that first to third high-definition video data (HD-Video) items 41 to 43 (for three channels) whose transmission rates are substantially the same are transmitted as shown in FIG. 8. The bandwidth of a low-band channel is substantially equal to that of a high-band channel. The first and second data items 41 and 42 for two channels are multiplexed, and the multiplexed data for one channel is transmitted through a low-band channel Ch_L1. The third data item 43 for one channel is transmitted as it is through a high-band channel Ch_H1. Thus, the rate at which data is transmitted through the low-band channel is twice as high as that at which data is done through the high-band channel, and almost the same transfer distance and transmission characteristics can be obtained in both high and low bands.

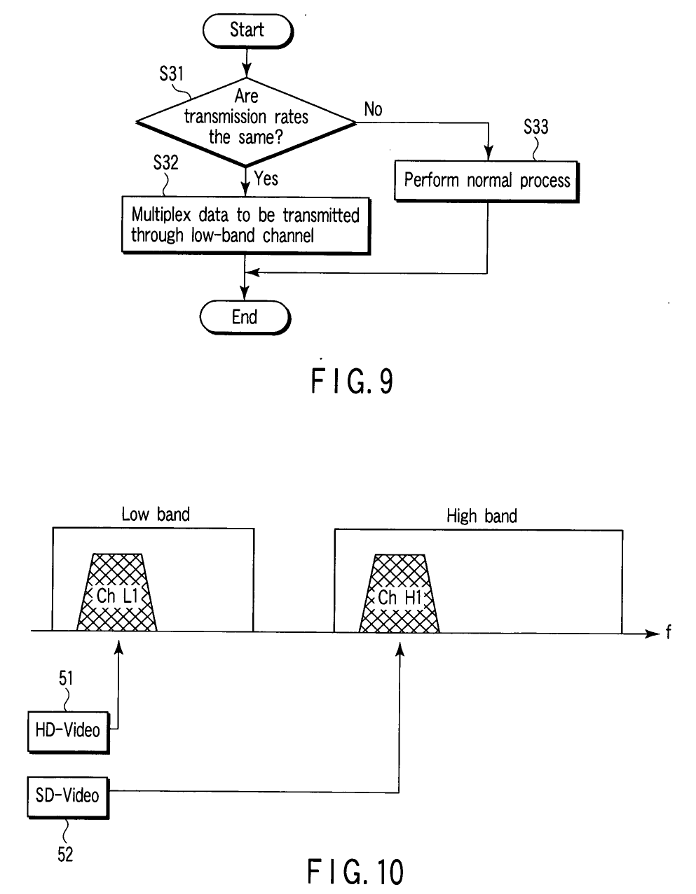

A procedure of the second method of controlling communications according to the second embodiment will be described with reference to FIG. 9.

Assume in the communication device shown in FIG. 1 that the first to third high-definition video data (HD-Video) items 41 to 43 are supplied from an AV device to the transmission unit 13 through the data processing unit 15 and then transmitted via the antenna 11. The determination unit 18 and control unit 19 perform the following processes.

The determination unit 18 determines whether or not the transmission rates of the data items 41 to 43 are the same (step S31). If they are the same (Yes in step S31), the control unit 19 multiplexes the data items 41 and 42 and assigns the multiplexed data to a low-band channel and assigns the data item 43 to a high-band channel (step S32). If the transmission rates are different (No in step S31), the control unit 19 does not perform the process of step S32 (step S33).

FIG. 10 is an illustration of the third method of controlling communications according to the second embodiment.

Referring to FIG. 10, a first high-definition video data (HD-Video) item 51 (for one channel) and a second standard video data (SD-Video) item 52 (for one channel) whose transmission rates are relatively different are transmitted through a low-band channel Ch_L1 and a high-band channel Ch_H1, respectively. The transmission rate of the data item 51 is higher than that of the data item 52. The bandwidth of the low-band channel is substantially equal to that of the high-band channel. Using the high-band channel rather than the low-band channel, a data transmission rate per unit band becomes low and almost the same transfer distance and transmission characteristics can be obtained in both high and low bands.

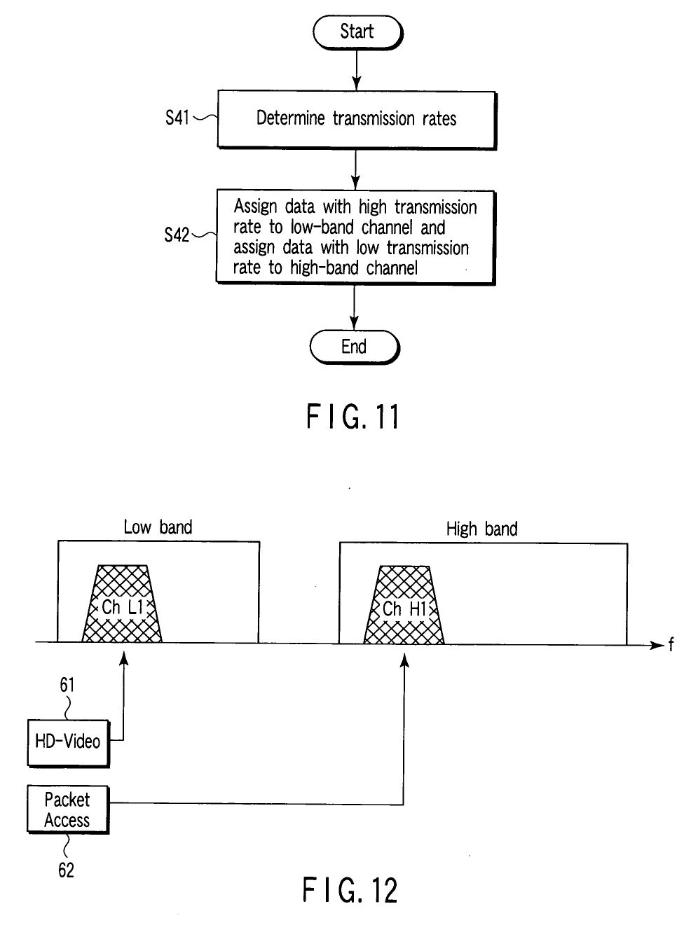

A procedure of the third method of controlling communications will be described with reference to FIG. 11.

Assume in the communication device shown in FIG. 1 that the data items 51 and 52 are supplied from an AV device to the transmission unit 13 through the data processing unit 15 and then transmitted via the antenna 11. The determination unit 18 and control unit 19 perform the following processes.

The determination unit 18 determines the transmission rates of the data items 51 and 52 (step S41). The control unit 19 assigns the data item 51 whose transmission rate is relatively higher to a low-band channel and assigns the data item 52 whose transmission rate is relatively lower to a high-band channel (step S42).

When data items of the same transmission rates or different ones are transmitted or received, a data transmission rate per unit band width is varied by, for example:
1) varying a channel coding rate;
2) varying the number of bit per modulated symbols;
3) varying the spreading rate of spectrum spread; or

Combination of at least two of 1) to 3) may be adopted.

These techniques can be applied to the above three methods of controlling communications.

According to the second embodiment, when two or more different data items are transmitted, a data transmission rate per unit band becomes lower in the case where a high-band channel is used than the case where a low-band channel is used. It is thus possible to prevent the propagation loss from increasing in the high band and prevent the propagation distance from being shortened.

### Third Embodiment

FIG. 12 is an illustration of a method of controlling communications according to the third embodiment of the present invention.

Referring to FIG. 12, a first high-definition video data (HD-Video) item 61 (for one channel) whose required transmission quality is relatively higher and a second high-definition video data (Packet Access) item 62 (for one channel) whose required transmission quality is relatively lower are transmitted through a low-band channel Ch_L1 and a high-band channel Ch_H1, respectively. The transmission quality of the data item 62 may be lower than that of the data item 61 since all or some of data items are retransmitted (ARQ) when an error is sensed on the reception side. It is thus possible to suppress the propagation loss of the data item whose required transmission quality is high.

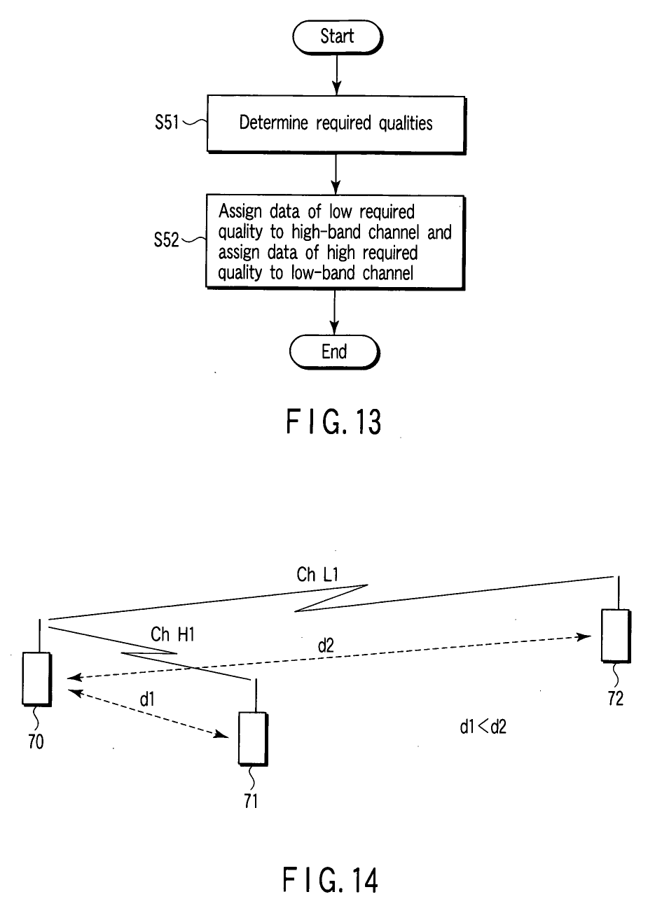

A procedure of the method of controlling communications according to the third embodiment will be described with reference to FIG. 13.

Assume in the communication device shown in FIG. 1 that the data items 61 and 62 are supplied from an AV device to a transmission unit 13 through a data processing unit 15 and then transmitted via an antenna 11. A determination unit 18 and a control unit 19 perform the following processes.

The determination unit 18 determines the transmission quality required for the data items 61 and 62 (step S51). The control unit 19 assigns the data item 62 whose required transmission quality is relatively lower to a high-band channel and assigns the data item 61 whose required transmission quality is relatively higher to a low-band channel (step S52).

According to the third embodiment, when two or more different data items are transmitted, the data item whose required transmission quality is relatively lower is assigned to a high-band channel. It is thus possible to suppress the propagation loss of the data item whose required transmission quality is high and achieve efficient communications.

### Fourth Embodiment

FIG. 14 is an illustration of a method of controlling communications according to the fourth embodiment of the present invention.

Assume that a communication device 70 corresponding to that shown in FIG. 1 performs communications with a communication device 71 and a communication device 72 as shown in FIG. 14. Data that is to be transmitted to (or received from) the device 71 at a shorter distance from the device 70 is assigned to a high-band channel Ch_H1, while data that is to be transmitted to (or received from) the device 72 at a longer distance from the device 70 is assigned to a low-band channel Ch_L1. It is thus possible to suppress the propagation loss of the data that is to be transmitted to (or received from) the device 72 at a longer distance from the device 70.

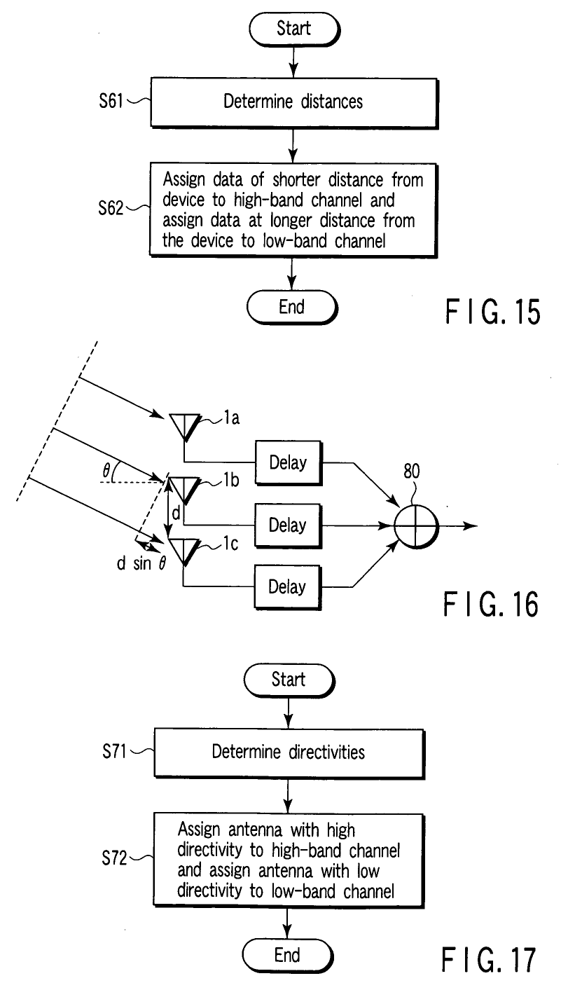

A procedure of the method of controlling communications according to the fourth embodiment will be described with reference to FIG. 15.

Assume in the communication device 70 that data that is to be transmitted to the communication device 71 from an AV device and data that is to be transmitted to the communication device 72 are supplied to a transmission unit 13 through a data processing unit 15 and then transmitted via an antenna 11. A determination unit 18 and a control unit 19 perform the following processes.

The determination unit 18 determines distance d1 between the devices 70 and 71 and distance d2 between the devices 70 and 72 (step S61). The control unit 19 assigns the data that is to be transmitted to the device 71 at a shorter distance from the device 70 to a high-band channel and assigns the data that is to be transmitted to the device 72 at a longer distance from the device 70 to a low-band channel (step S62).

According to the fourth embodiment, when data is transmitted from the same communication device to two or more different communication devices, data that is to be transmitted to (or received from) the communication device at a shorter distance to a high-band channel. It is thus possible to suppress the propagation loss of data that is to be transmitted to (or received from) a communication device at a longer distance and achieve efficient communications.

### Fifth Embodiment

FIG. 16 is an illustration of a method of controlling communications according to the fifth embodiment of the present invention.

To obtain the directivity of an antenna 11, a synthesis unit 80 appropriately synthesizes signals that are received by a number of elements 1a, 1b, and 1c. The signals received by the elements differ in propagation distance. Assuming that the distance between the elements is d and the incident angle of each of the signals is θ, the difference in propagation distance is represented by “d·sin θ”. This difference causes a difference in delay in the propagation among the signals and a difference in phase among the signals. The synthesized signals generate the directivity corresponding to the incident angle. In particular, when the wavelength of the signals is short, the directivity is generated even though the difference in delay is small. In other words, when the wavelength is short, the distance d between the elements required to obtain the same directivity becomes short, with the result that the antenna can be reduced in size. The shorter the wavelength, the smaller the elements. The higher the degree of the directivity (the more acute the directivity) of the antenna, the larger the number of elements required. If, therefore, the wavelength of the signals received by antenna units having a large number of elements is short, an antenna including antenna units for the low- and high-bands can be reduced in size. In the fifth embodiment, a plurality of antenna units (different antenna patterns) make up the antenna 11, and data that is to be transmitted to/received from the antenna unit the degree of the directivity of which is relatively higher is assigned to a high-band channel whose wavelength is short. Accordingly, the antenna 11 can be reduced in size.

In the fifth embodiment, a large number of elements make up a directivity antenna. Instead of this, a directivity antenna using a horn can be adopted.

A procedure of the method of controlling communications according to the fifth embodiment will be described with reference to FIG. 17.

A determination unit 18 determines an antenna unit the degree of the directivity of which is relatively higher and an antenna unit the degree of the directivity of which is relatively lower in the antenna 11 (step S71).

A control unit 19 assigns data, which is to be transmitted to/received from the antenna unit the degree of the directivity of which is relatively higher, to a high-band channel whose wavelength is short, and assigns data, which is to be transmitted to/received from the antenna unit the degree of the directivity of which is relatively lower, to a low-band channel whose wavelength is long (step S72).

According to the fifth embodiment, when an antenna has different antenna patterns, data that is to be transmitted to/received from the antenna unit the degree of the directivity of which is relatively higher is assigned to a high-band channel whose wavelength is short. The antenna can thus be reduced in size to achieve efficient communications.

In the first to fifth embodiments, a single communication device can transmit data through a low-band channel and transmit data through a high-band channel. The present invention is not limited to this, but different communication devices can be used to do so.

In the foregoing embodiments, a communication device mainly transmits data. Needless to say, it can receive data.

The first to fifth embodiments may be selectively combined to realize the present invention. For example, the fourth embodiment may be combined with the first embodiment and the fifth embodiment may be combined with the first embodiment.

As described above in detail, the present invention can improve the efficiency of communications in broadband radio communications.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication device, comprising:
a communication unit capable of performing radio communications in a broad band including a first band whose frequency is relatively higher and a second band whose frequency is relatively lower;
a determination unit which determines whether or not a channel in the first band is usable; and
a control unit which preferentially assigns data to be transmitted or received to the channel in the first band when the channel in the first band is usable.

2. A communication device, comprising:
a communication unit capable of performing radio communications in a broad band including a first band whose frequency is relatively higher and a second band whose frequency is relatively lower, and which transmits or receives at least two different data items; and
a control unit which controls the communication unit to perform communications in which a data transmission rate per unit band width is lower in a case where a channel in the first band is used than a case where a channel in the second band is used.

3. The communication device according to claim 2, wherein the two different data items include a first data item and a second data item whose transmission rates are substantially equal to each other, and the control unit assigns the first data item to the channel in the first band and assigns the second data item to the channel in the second band while a bandwidth of the channel in the first band is broader than that of the channel in the second band.

4. The communication device according to claim 2, wherein the different two data items include a first data item, a second data item and a third data item whose transmission rates are substantially equal to one another, and the control unit multiplexes the first data item and the second data item and assigns the multiplexed first and second data items to the channel in the second band, and assigns the third data item to the channel in the first band.

5. The communication device according to claim 2, wherein the two different data items include a first data item whose transmission rate is relatively lower and a second data item whose transmission rate is relatively higher, and the control unit assigns the first data item to the channel in the first band and assigns the second data item to the channel in the second band.

6. A communication device, comprising:
a communication unit capable of performing radio communications in a broad band including a first band whose frequency is relatively higher and a second band whose frequency is relatively lower, and which transmits or receives a first data item whose required transmission quality is relatively lower and a second data item whose required transmission quality is relatively higher; and
a control unit which assigns the first data item to a channel in the first band and assigns the second data item to a channel in the second band.

7. The communication device according to claim 1, wherein the communication unit performs communication with a first communication unit at a relatively shorter distance from the communication device and performs communication with a second communication unit at a relatively longer distance from the communication device; and
the control unit is configured to assign data, which is to be transmitted to or received from the first communication unit, to a channel in the first band and configured to assign data, which is to be transmitted to or received from the second communication unit, to a channel in the second band.

8. The communication device according to claim 1, further comprising a first antenna unit a degree of directivity of which is relatively lower and a second antenna unit a degree of directivity of which is relatively higher; and
the control unit being configured to assign data, which is to be transmitted or received by the first antenna unit, to a channel in the second band and configured to assign data, which is to be transmitted or received by the second antenna unit, to a channel in the first band.
